(19) United States
(12) Patent Application Publication
(10) Pub. No.: US 2005/0054286 A1
(43) Pub. Date: Mar. 10, 2005

(54) Method of providing live feedback

(76) Inventors: Jawahar Kanjilal, Singapore (SG); Peter Dam Nielsen, Bronshoj (DK); Hemant Madan, Espoo (FI); Mikko Makipaa, Helsinki (FI)

Correspondence Address: BANNER & WITCOFF, 1001 G STREET N W, SUITE 1100, WASHINGTON, DC, 20001, US

(21) Appl. No.: 10/492,350

(22) PCT Filed: Oct. 15, 2001
(86) PCT No.: PCT/EP01/11940

(51) Int. Cl. H04H 9/00

(52) U.S. Cl. 455/3.05; 455/3.06; 455/2.01

(57) ABSTRACT

A radio station (1) transmits a radio programme using a VHF-FM singal which is received by a WAP-enabled mobile commnicaitons device (3). The signal includes radio datea service (RDS) data which includes the URL of a web-site associated with the radio station. The user accesses the web-page and participates in an opinion poll by casting a vote. The server logs the vote. The radio station counts the votes and announces the votes while the radio programme is still on air.

### FIELD OF THE INVENTION

The present invention relates to a method of providing live feedback to a provider of a broadcast programme using a mobile communications device.

### BACKGROUND ART

Radio programme makers often invite listeners to contact them to participate in discussions, opinion polls and competitions. This process usually involves the programme maker broadcasting a telephone number or postal address and the listener calling or writing to them. Postal competitions and opinion polls are undeniably slow. However, even telephone polls lack instantaneity, particularly if many listeners are involved. It takes time to establish a call centre or configure an automated call register. Thus, polls are normally planned in advance of programmes being broadcast. Not only does this restrict spontaneity, but also the frequency with which polls can be conducted. It is unusual for a programme lasting a few hours to conduct more than one poll.

The present invention seeks to provide an improved method of providing feedback to a provider of a broadcast radio programme.

Listeners to radio programmes also like to call the programme makers to air an opinion or greeting. At present, listeners' calls are taken by a member of the production team or a switchboard operator. The call is then aired or the message noted down and read out by a radio presenter. Both procedures require the radio station to provide substantial resources for such a service.

The present invention also seeks to provide an improved method of allowing listeners to broadcast messages to the listening public.

Radio stations are not alone in conducting opinion polls. Users of mobile communications devices often contact other users to gauge their opinion or allow them to express a choice. This usually involves either calling the other users or sending a text message to them. If the recipient receives a message, their handset usually provides an option to reply to the message. However, this involves writing a new message.

The present invention also seeks to provide an improved method of exchanging messages between mobile communications devices.

### SUMMARY OF THE INVENTION

According to the present invention there is provided a method of providing live feedback to a producer of a broadcast radio programme using a mobile communications device, the method comprising transmitting a stream of radio programme content from the producer to the device, transmitting a message originating from the producer for a user of said device to respond thereto and receiving, at a server means associated with said producer, a response to the message while said stream is still being transmitted.

The method may comprise extracting said message from said stream of programme content. The method may comprise receiving said stream of programme content via a first network and receiving said message via a second, different network. The receiving of said message via a second, different network may comprise obtaining said message via a public land mobile network. The receiving of said message may include receiving information relating to a plurality of selectable options.

The method may further comprise configuring said device in dependence upon said message such that each option is assigned a respective input means. The transmitting of said response may comprise sending a response message relating to one of said selectable options.

The method may comprises transmitting to one or more mobile communications devices said message including information relating to a plurality of selectable options, receiving a response from at least some of said devices, each response including data relating to a selected one of said options and generating a poll result from said responses. The method may also comprise preparing a chat message sing a mobile communications device, transmitting said chat message via a communications network to a server means associated with the producer, broadcasting said chat message via a broadcasting network.

The method may further comprise the user making an electronic transaction.

The method may comprise the producer providing the server means. The method may comprise the producer configuring the server means to permit the server means to receive a response from a mobile communications device and retrieving the response from the server means.

The method may comprise transmitting to one or more mobile communications devices said message including information relating to a plurality of selectable options, receiving a response from at least some of said devices, each response including data relating to a selected one of said options and generating a poll result from said responses.

The method may comprise preparing another message using a mobile communications device, transmitting said another message via a communications network to a server means associated with the producer, broadcasting said another message via a broadcasting network.

According to the present invention there is also provided a system for allowing a mobile communications device to provide live feedback to a producer of a broadcast radio programme, comprising means for producing a stream of radio programme content from the producer to the device, means for transmitting a message originating from the producer for a user of said device to respond thereto and server means for receiving a response to said message while said stream is still being producing.

The means for transmitting said message for said user of said device to respond thereto may include means for producing radio system data. The means for transmitting said message for a user of said device to respond thereto may include a digital audio broadcasting network. The message may be included in a digital audio frame. The message may be included in programme associated data included in said digital audio frame. The means for transmitting said message for a user of said device to respond may include the and/or another server means. The message may be included in a page provided by the server means. The server means may be a wireless application protocol (WSAP) server.

According to the present invention there is also provided a system for allowing a mobile telecommunications device to provide live feedback to a producer of a broadcast radio programme, comprising means for producing a stream of radio programme content, means for transmitting a message originating from said producer for a user of said device to respond thereto, means for receiving data, from a server means, relating to a response to said message, said data being received while said stream is still being produced.

According to the present invention there is also provided a mobile communications device for providing live feedback to a producer of a broadcast radio programme, the device comprising means for receiving a stream of radio programme content from said producer, means for receiving a message originating from said producer for a user of said device to respond thereto and means for transmitting a response to a server means associated with the producer for providing feedback while said stream is still being received.

The means for receiving said stream of radio programme content may comprise means for receiving digital radio broadcast. The means for receiving said message may comprise means for receiving digital radio broadcast. The means for receiving said message may comprise means for receiving broadcast radio. The means for receiving said message may comprise means for radio data system data. The means for receiving said message may comprise means for accessing said and/or another server means.

The device may be WAP-enabled. The device may be a handset. The device may be a PDA.

According to the present invention there is also provided a method of conducting a poll of one or more mobile communications devices by a producer of a broadcast radio programme, the method comprising transmitting to said one or more mobile communications devices a stream of radio programme content, transmitting to said one or more mobile communications devices a message including information relating to a plurality of selectable options, receiving, at a server means associated with said producer, a response from at least some of said devices, each response including data relating to a selected one of said options and generating a poll result from said responses while said stream is still being transmitted,

According to the present invention there is also provided a method of broadcasting comprising preparing a message using a mobile communications device, transmitting said message via a communications network to a server means associated with a radio broadcaster and broadcasting said message via a broadcasting network.

According to the present invention there is also provided a method of chat comprising preparing a message using a mobile communications device, transmitting said message via a communications network to a server means associated with a radio broadcaster and broadcasting said message via a broadcasting network.

The method may comprise converting said message into a voice message and broadcasting said voice message via said broadcasting network. The method may comprise broadcasting said message as data together with an audio signal. The broadcasting of said data may comprise transmitting radio data system data. The broadcasting of said data may comprise transmitting a plurality of RDS data messages

The method may comprise broadcasting said message using frequency modulated (FM) signals The receiving of said response may comprise receiving a short message service (SMS) message.

According to the present invention there is also provided a method of chat comprising receiving a chat message from a communications network and broadcasting a corresponding message via a broadcasting network, the broadcasting of said corresponding message may comprise transmitting a radio data service (RDS) message.

The receiving of the chat message may comprise receiving a short message service (SMS) message. The broadcasting of said corresponding message may comprise transmitting a plurality of RDS messages.

### BRIEF DESCRIPTION OF THE DRAWINGS

Embodiments of the present invention will now be described, by way of example, with reference to the accompanying drawings in which:

FIG. 1 is a schematic block diagram illustrating a radio station, a mobile communications device, a broadcasting network and a public land mobile network in a first embodiment of the present invention;

FIG. 2 is a schematic diagram of the mobile communications device shown in FIG. 1;

FIG. 3 is a schematic block diagram of the circuitry of the mobile communications device shown in FIG. 2;

FIG. 4 is a schematic block diagram of part of a radio station and associated networks;

FIG. 5a shows a template web page;

FIG. 5b shows the template web page of FIG. 5a after having been amended;

FIG. 5c shows a web page posted on a server;

FIG. 6 illustrates a procedure by which a user of mobile communications device elects to use the device as a radio set;

FIG. 7 illustrates a procedure by which a user of a mobile communications device participates in a poll including a voting procedure;

FIG. 8 illustrates an alternative voting procedure which can be used in the procedure shown in FIG. 7;

FIG. 9 illustrates a procedure by which a server computer manages an opinion poll;

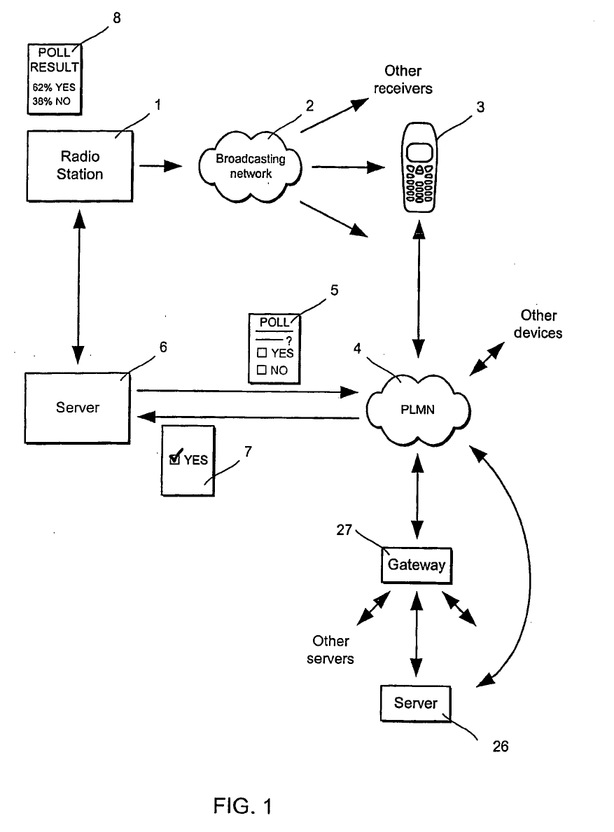

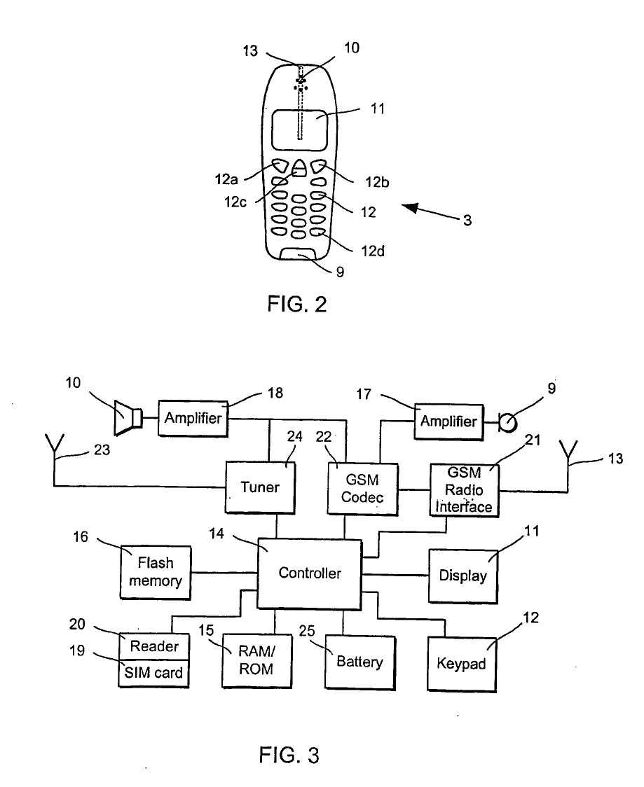

FIG. 2 is a schematic diagram of the mobile communications device shown in FIG. 1;

FIG. 3 is a schematic block diagram of the circuitry of the mobile communications device shown in FIG. 2;

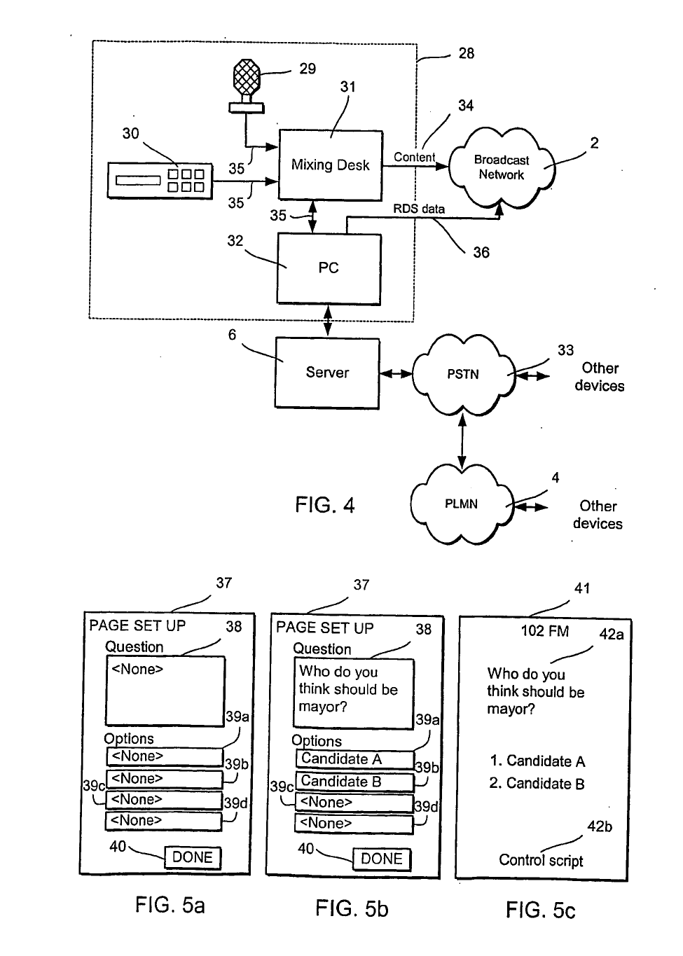

FIG. 4 is a schematic block diagram of part of a radio station and associated networks;

FIG. 5a shows a template web page;

FIG. 5b shows the template web page of FIG. 5a after having been amended;

FIG. 5c shows a web page posted on a server;

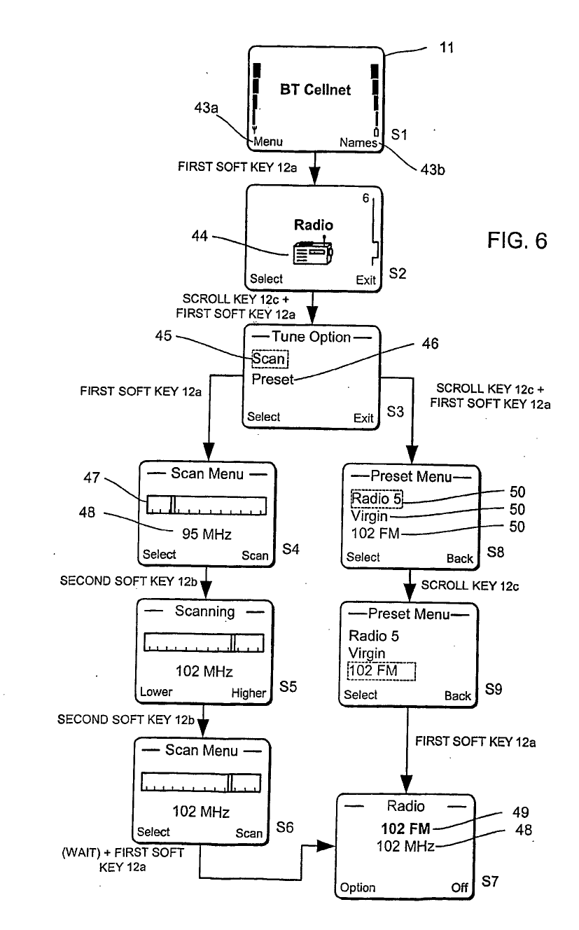

FIG. 6 illustrates a procedure by which a user of mobile communications device elects to use the device as a radio set;

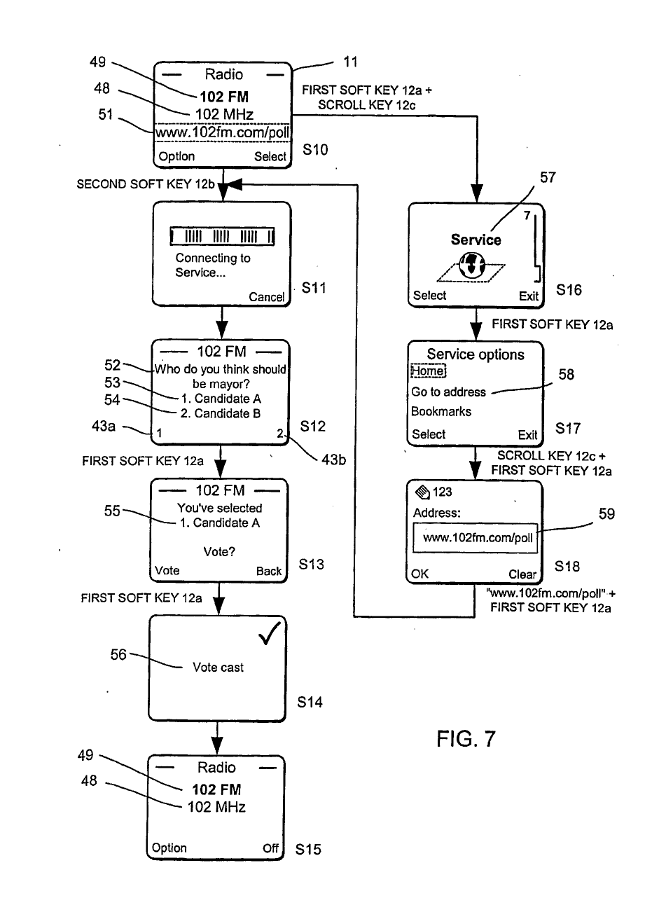

FIG. 7 illustrates a procedure by which a user of a mobile communications device participates in a poll including a voting procedure;

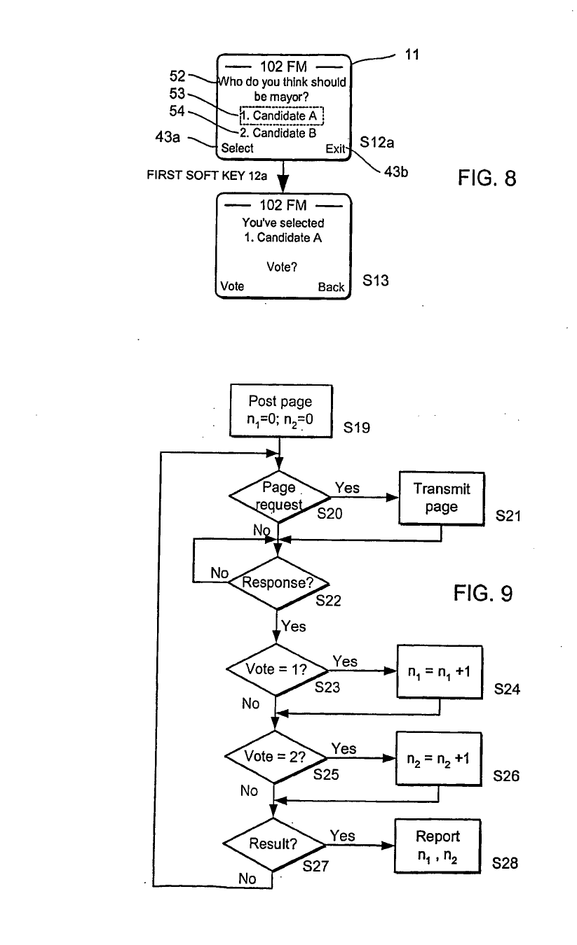

FIG. 8 illustrates an alternative voting procedure which can be used in the procedure shown in FIG. 7;

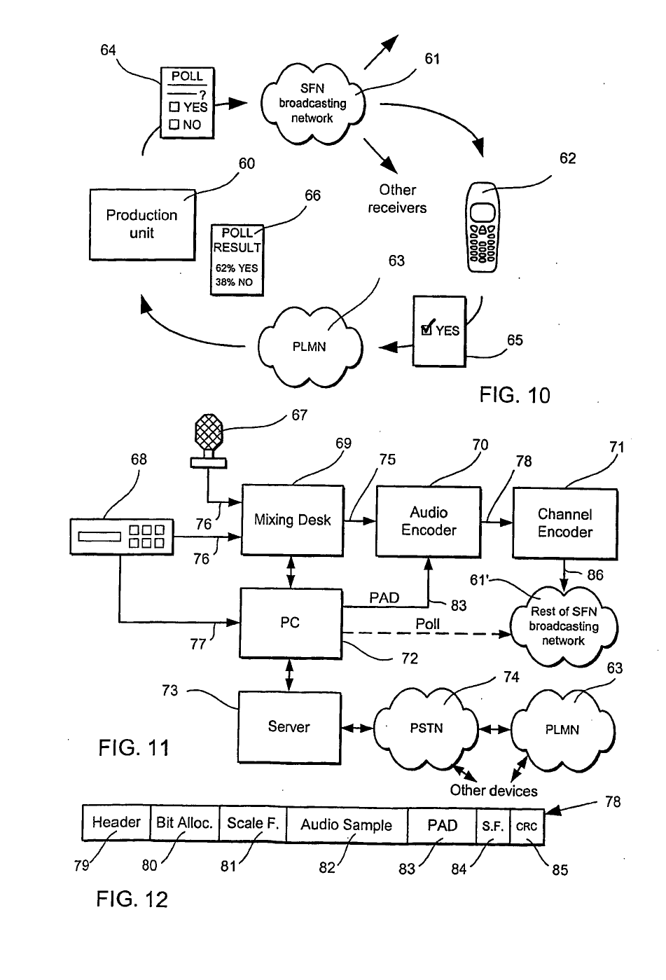

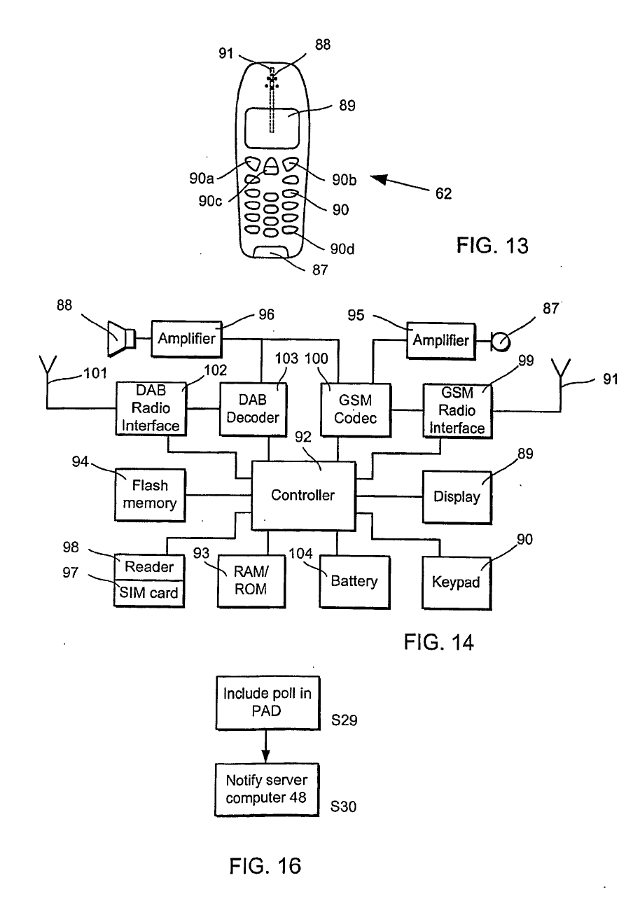

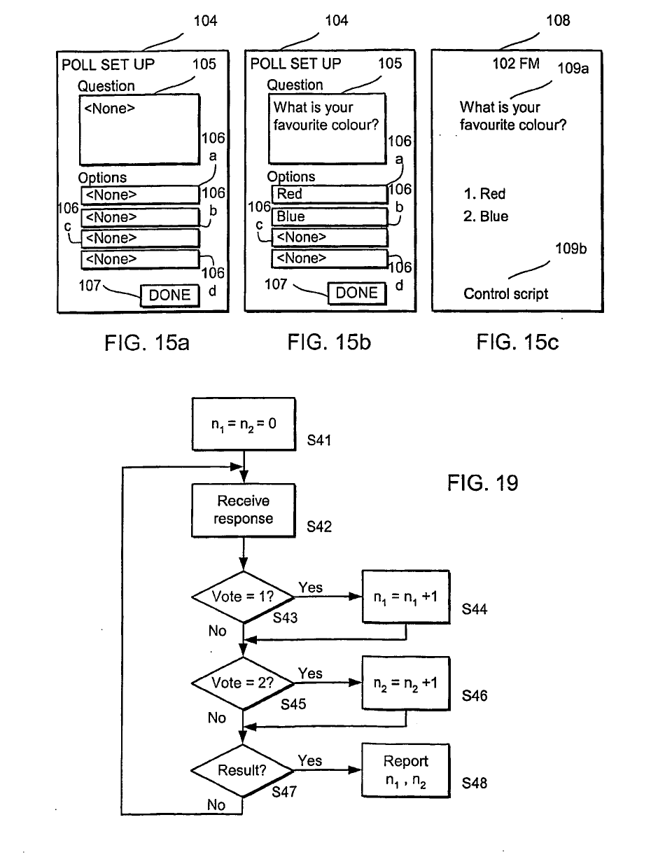

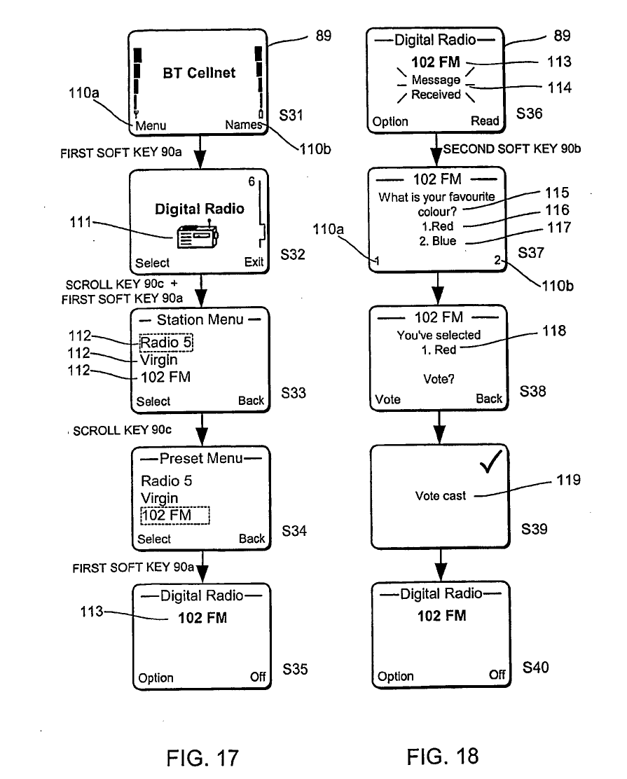

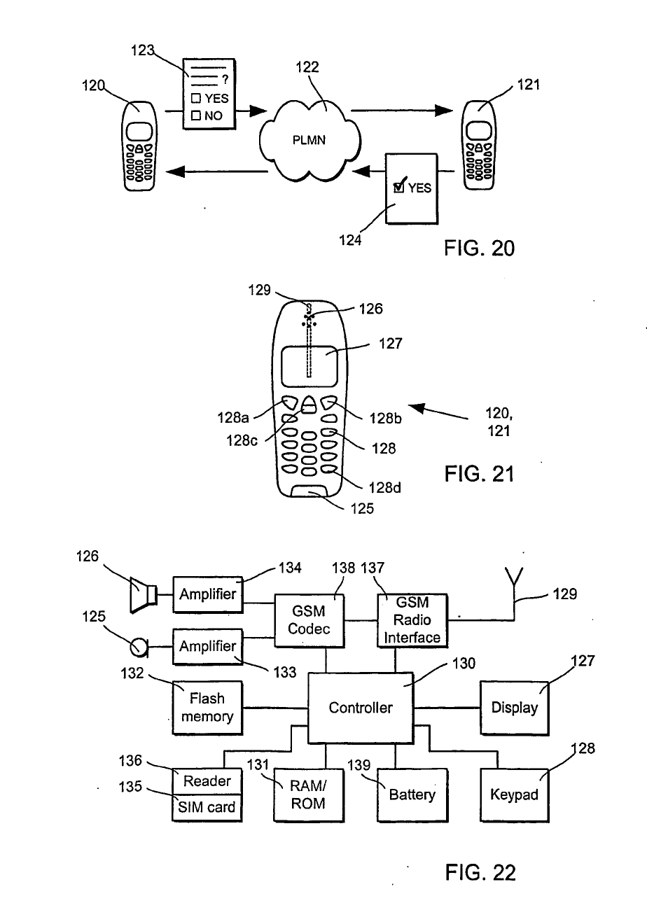

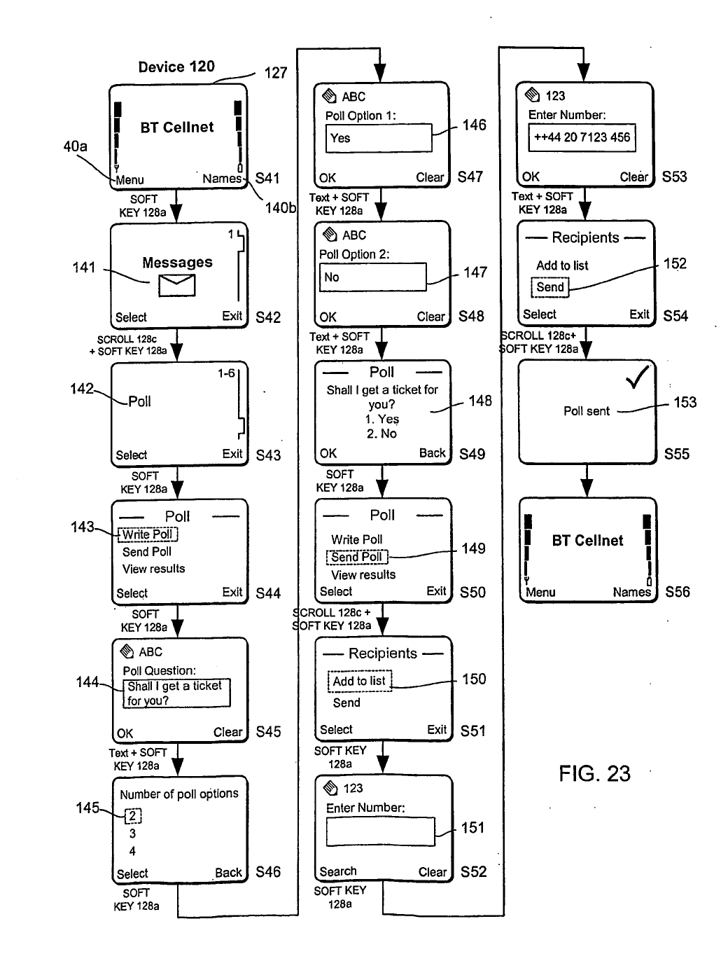

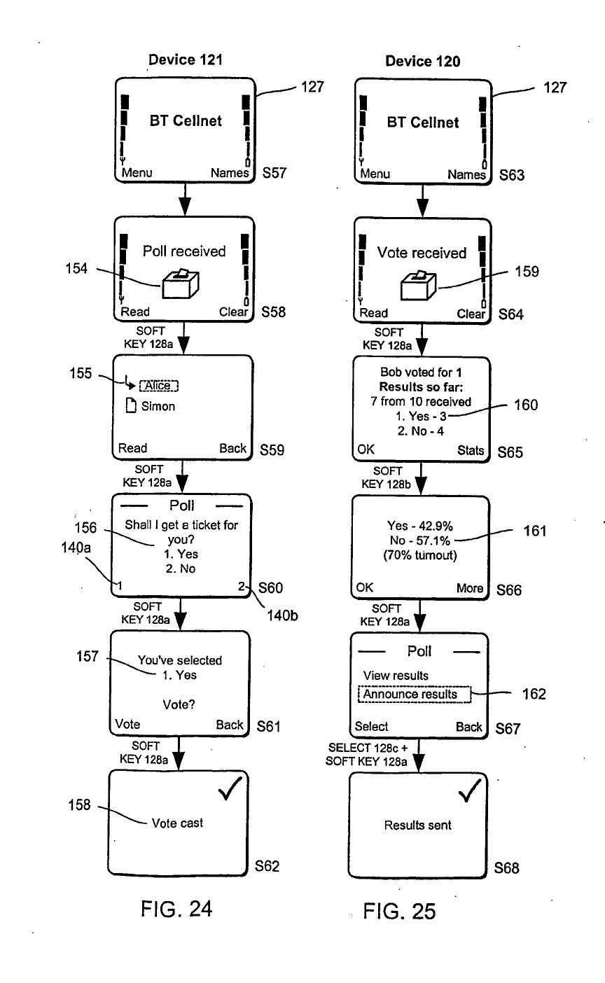

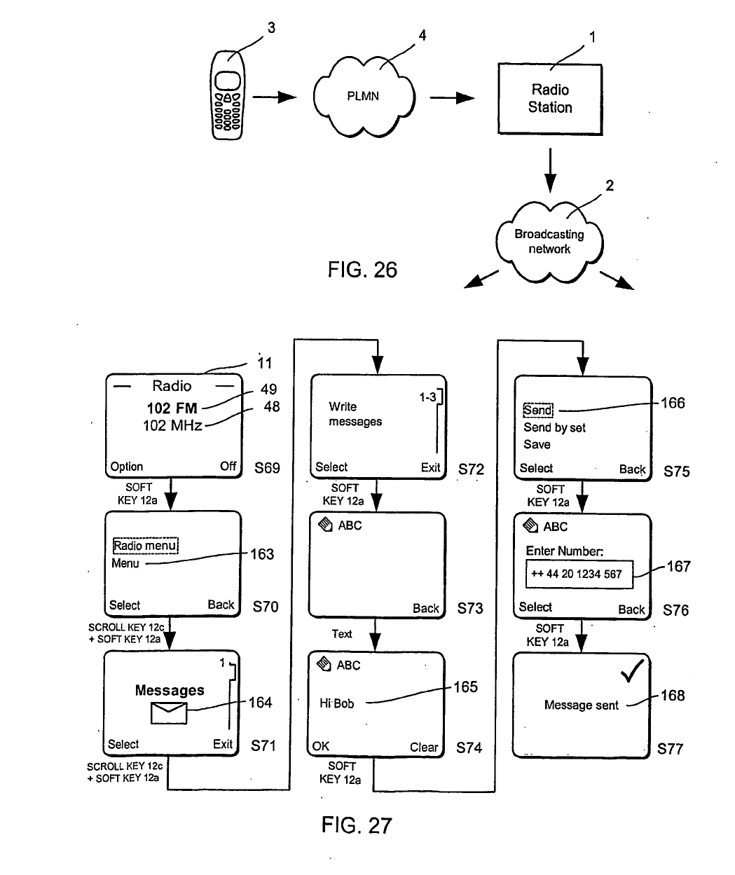

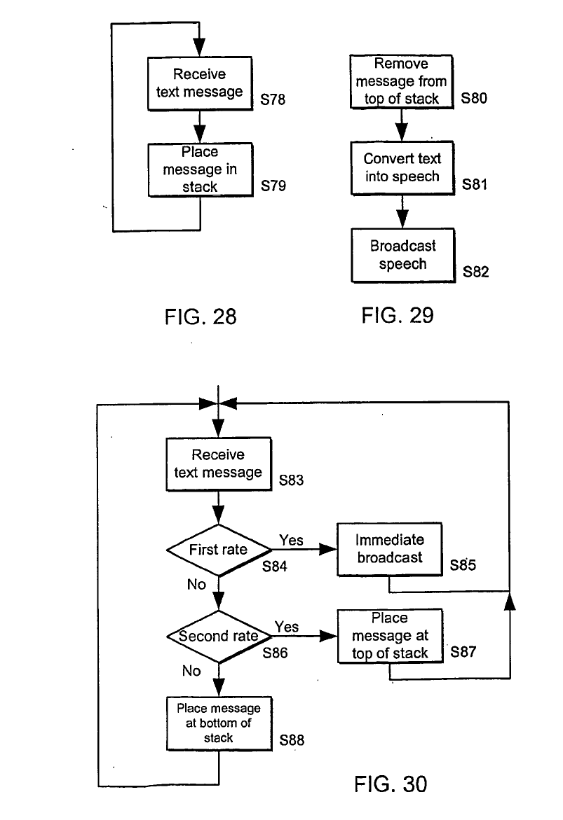

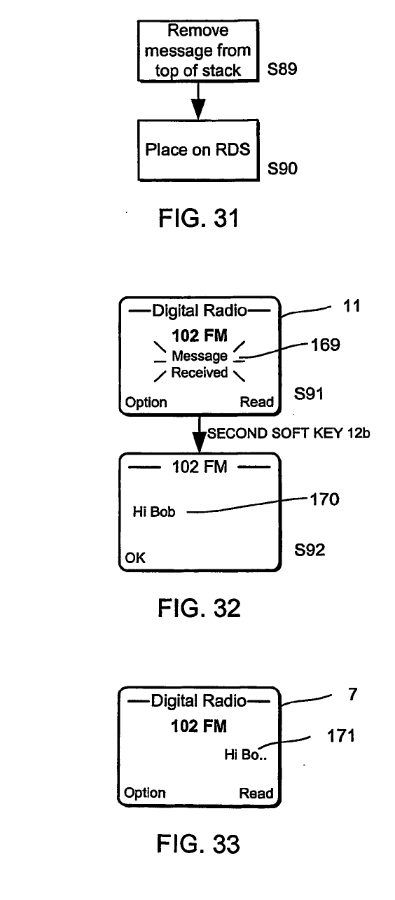

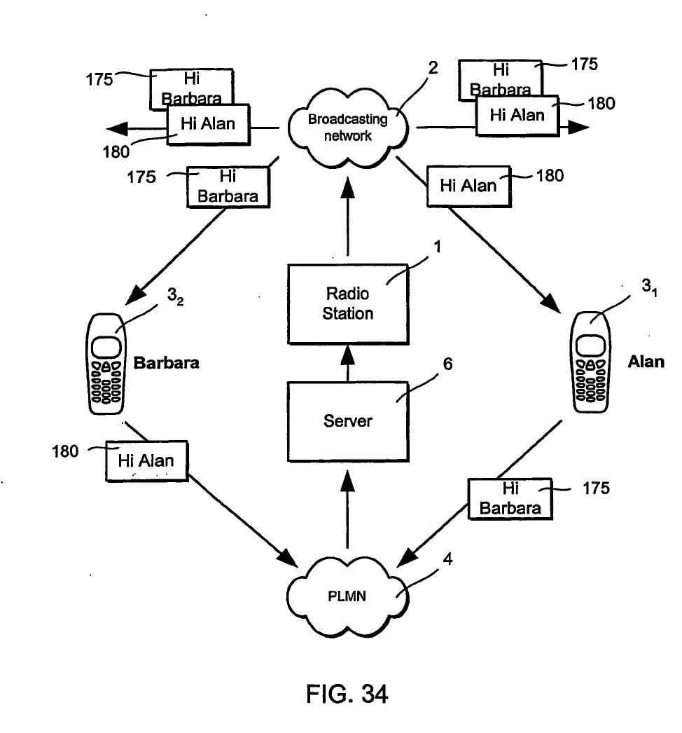

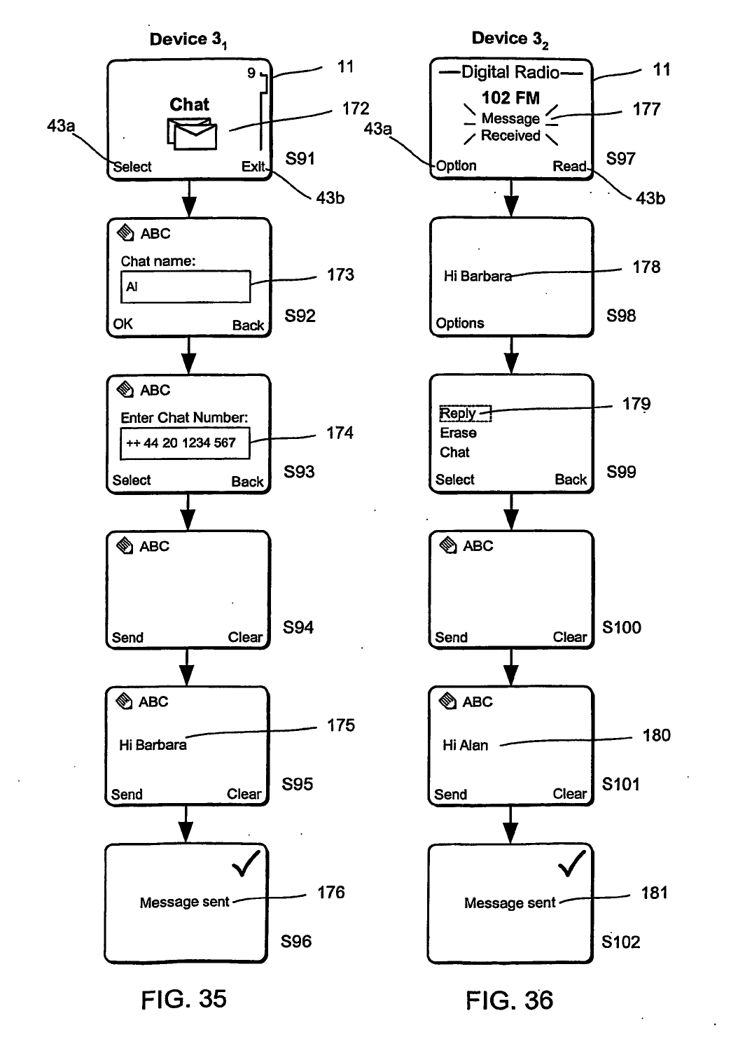

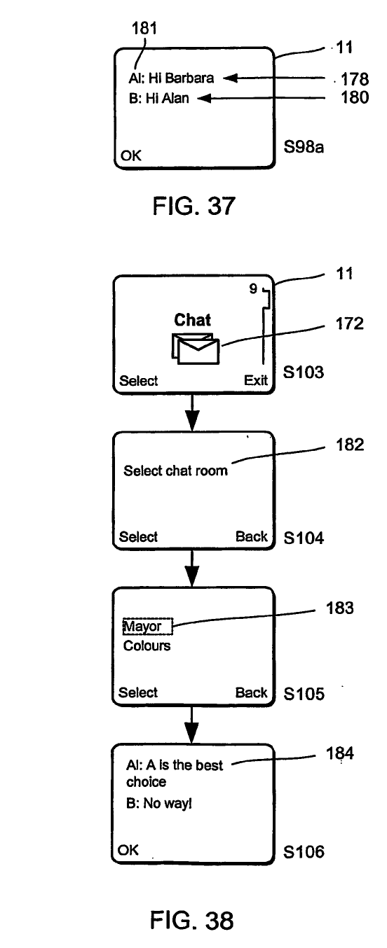

FIG. 9 illustrates a procedure by which a server computer manages an opinion poll;

FIG. 10 is a schematic block diagram illustrating a radio programme production unit, a mobile communications device, a single frequency broadcasting network and a public land mobile network in a second embodiment of the present invention;

FIG. 11 is a schematic block diagram of a production unit and associated networks;

FIG. 12 shows an audio frame including programme associated data;

FIG. 13 is a schematic diagram of a mobile communications device;

FIG. 14 is a schematic block diagram of the circuitry of the mobile communications handset shown in FIG. 13;

FIG. 15a shows a template web page;

FIG. 15b shows the template web page of FIG. 15a after having been amended;

FIG. 15c shows a web page posted on a server;

FIG. 16 illustrates a procedure by which a personal computer initiates a poll;

FIG. 17 illustrates a procedure by which a user of mobile communications device elects to use the device as a digital radio set;

FIG. 18 illustrates a procedure by which a user of a mobile communications device participates in a poll;

FIG. 19 illustrates a procedure by which a server computer manages am opinion poll;

FIG. 20 is a schematic block diagram of two mobile communication devices exchanging messages;

FIG. 21 is a schematic diagram of a mobile communications device shown in FIG. 20;

FIG. 22 is a schematic block diagram of the circuitry of the mobile communications handset shown in FIG. 21;

FIG. 23 illustrates a procedure by which a device prepares and distributes a poll;

FIG. 24 illustrates a procedure by which a recipient casts a vote;

FIG. 25 illustrates a procedure by which an initiator gathers votes;

FIG. 26 is a schematic block diagram illustrating a radio station, a mobile communications device, a broadcasting network and a public land mobile network in a third embodiment of the present invention;

FIG. 27 illustrates a procedure by which a chat message is prepared and sent to a radio station;

FIG. 28 illustrates a procedure by which a chat message is placed in a stack;

FIG. 29 illustrates a procedure by which chat messages are retrieved from a stack;

FIG. 30 illustrates an alternative procedure by which a chat message is place in a stack;

FIG. 31 illustrates a procedure by which chat messages are transmitted using RDS;

FIG. 32 illustrates a procedure by which a mobile communications device displays a chat message received using RDS;

FIG. 33 shows a display of a mobile communications device displaying a ticker-tape message received by RDS;

FIG. 34 shows a modified view of the system shown in FIG. 1 including first and second communications devices;

FIG. 35 illustrates another procedure by which a chat message is transmitted using RDS;

FIG. 36 illustrates another procedure by which a chat message is received using RDS;

FIG. 37 illustrates another way of presenting chat messages; and

FIG. 38 illustrates different chat channels.

### PREFERRED EMBODIMENTS OF THE INVENTION

First Embodiment

Referring to FIG. 1, in a first embodiment of the present invention, a radio programme producer, for example radio station 1, transmits signals, preferably very-high frequency (VHF) frequency-modulated (FM) signals, through a broadcasting network 2 for reception by radio receiver sets (not shown) and a multi-functional mobile communications device 3 in the form of mobile communications handset. The device 3 can communicate with mobile and fixed communication devices (not shown) through a public land mobile network (PLMN) 4, such as a GSM network.

In this embodiment, the radio station 1 notifies the user that there is an opinion poll 5 and provides the user with information for obtaining the poll 5 from a server 6, in this case a WAP server, through the PLMN 4. The user sends a reply 7, including his vote, to the server 6, through the PLMN 4. The radio station 1 collects the votes from the server 6 and generates a poll result 8.

Referring to FIG. 2, the device 3 is at least dual-function in that it provides wireless application protocol (WAP)-enabled mobile telephone functionality and broadcast radio receiver functionality. The device 3 includes a microphone 9, speaker 10, liquid crystal display (LCD) 11, keypad 12 and internal antenna element 13. The keypad 12 includes first and second soft keys 12a, 12b, a bi-directional scroll key 12c and an alphanumeric set of keys 12d.

Referring also to FIG. 3, the circuitry of the mobile communications device 3, includes a microcontroller 14, RAM/ROM 15 and flash memory 16. Electrical analogue signals are produced by the microphone 9 and amplified using amplifier 17. Similarly, analogue audio signals are fed to the speaker 10 through an amplifier 18. The microcontroller 14 receives instructions from the keypad 12 and controls operation of the LCD 11. Information concerning the identity of the user is held on a smart card 19 in the form of a GSM SIM card. The SIM card 19 is removably received in a SIM card holder 20 connected to the microcontroller 14.

Communication radio signals, to and from the PLMN 4 (FIG. 1), are transmitted and received by means of the antenna element 13 connected through an r.f. stage 21 to a coder/decoder 22, often referred to simply as a codec, which is configured to process signals under the control of the microcontroller 14.

Broadcast radio signals from the broadcasting network 2 (FIG. 1) ate received using an internal aerial 23 connected to a tuner 24. It will be appreciated that a single antenna can be used to feed signals to the r.f. stage 21 and the tuner 24. It will also be appreciated that the tuner 24 may be integrated into the r.f. stage 21. The device 3 is powered by a rechargeable battery 25 or power source (not shown).

When the device 3 is used as a mobile telephone handset, the codec 22 receives analogue signals from the microphone amplifier 17, digitises them into a form suitable for transmission and feed them to the r.f. stage 21 for transmission through the antenna element 13 for transmission to the PLMN 4 (FIG. 1). Similarly, signals received from the PLMN 4 are fed through the antenna element 13 to be demodulated by the r.f. stage 21 and fed to codec 22 so as to produce analogue signals which are fed though the amplifier 18 to speaker 10.

When the device 3 is used as a radio set, signals received from the broadcasting network 2 (FIG. 1) are fed through the aerial 23 to the tuner 24 where they are demodulated and fed through the amplifier 18 to speaker 10.

Thus, the mobile communications device 3 can be used as a mobile communications handset for voice and data services and as a radio set. These functions can be performed separately or simultaneously. For example, a user can send a text message while listing to the radio.

Referring to again to FIG. 1, the device 3 is also configured to operate as a client to receive data from remote servers 6, 26 and to communicate through PLMN 4 with either a gateway 27 which acts as a proxy server for connection to remote servers 6, 26 or directly with remote servers 6, 26. For example, for a WAP-enabled system, access to the gateway 27 is provided by dialling a telephone number associated with the gateway 27 although other communication techniques can be used e.g. for GPRS and UMTS. The server 26 may provide data corresponding to individual sites each with an individual homepage with a specific network address or universal resource locator (URL). The data may be provided in WML through the PLMN 4 to the device 3, which acts as a mobile client. Instead of using WML, the data may be provided in XHTML from the server 26, through the PLMN 4 to the device 3 without the need for a gateway 27. XHTML is a follow-on version to HTML 4.0.

Referring to FIGS. 1, 2 and 3, the device 3 runs a microbrowser. The software for running the microbrowser may be held in flash memory 16 shown in FIG. 3, so as to be run by the microcontroller 14 and provide an output on the LCD 11. As will be explained in more detail hereinafter, the device 3 is used to access the server 6 which is associated with the radio station 1 through the PLMN 4. During a WAP session, the device 3 may download a message in the form of an opinion poll and transmits a response, i.e. casts a vote.

Referring to FIG. 4, the radio station 1 includes a studio 28 provided with a microphone 29, a music player 30 and a mixing desk 31. The studio 28 is also provided with a personal computer 32, which is connected to the server computer 6. The server computer 6 may be located on the premises of the radio station 1 or remotely. The server 6 is connected to a PSTN 33 via a modem (not shown). The PSTN 33 is connected to the PLMN 4. The server 6 can connected directly to the PLMN 4.

A radio programme is produced in the studio 28 and comprises a stream of audio content 34. The audio content 34 includes speech, music and other audio signals. The microphone 29 and music player 30 produces audio signals 35 which ate processed and mixed at the mixing desk 31. Audio signals 35 may also be produced by the personal computer 32. The resulting signal, which embodies the audio content 34, is passed on to the network 2 to be broadcast, for example in a 200 kHz band using a carrier signal at 102 MHz, from a plurality of transmitter sites (not shown) throughout a broadcasting region. Radio data system (RDS) data 36 can also be passed on to the network 2 to be broadcast.

A method by which a listener can interact with a radio programme will now be described.

A radio programme presenter spontaneously decides to conduct an opinion poll as to who should become the next mayor.

Referring to FIG. 5a, a member of the production team prepares the poll by accessing the server computer 6 using personal computer 32 and amending a template XHTML page 37. The page 37 includes a first dialogue box 38 for entering a question and a plurality of additional dialogue boxes 39a, 39b, 39c, 39d for entering possible answers.

Referring to FIG. 5b, the production team member enters a poll question “Who do you think should become mayor?” in the first dialogue box 38 and enters the names of two candidates in first and second additional dialogue box 39a, 39b. Once completed, the production team member selects “Done” 40.

Referring to FIG. 5c, a web-page 41 is posted on the server computer 6 ready to be accessed. The web-page 41 might be in XHTML format and configured to be viewed using a microbrowser by device 3 (FIG. 1). The web-page 41 includes text 42a relating to the poll question and answers and also script 42b for configuring the device 3, particularly the device's user interface. As will be explained in more detail later, when the page is accessed, the user can vote using the keypad 12 (FIG. 2). The vote is transmitted to the server computer 6, where it is logged.

Referring to again FIG. 4, the presenter announces “on-air”, i.e. while the stream of audio content 34 is being transmitted, that there is going to be an opinion poll and invites listeners to access a web-site associated with the radio programme and hosted by the server computer 6. The announcement includes the URL of the web-site and may also include a telephone number. Alternatively or additionally, since the broadcasting network 2 transmits FM signals, the URL is included as radio data service (RDS) data 36. Thus, the personal computer 32 sends the URL as a data string to the broadcasting network 2. The data is transmitted in a portion of the radio frequency spectrum allocated to the radio station 1 but unused for transmitting the audio content. In this example, the portion of the spectrum comprises a 57 kHz band. The data may be RadioText (RT) coded.

A process by which the user listens to the radio programme and interacts with the programme maker will now be described.

In FIG. 6, outputs are displayed on the LCD 11 including first and second legends 43a, 43b indicating the function of the first and second softkeys 12a, 12b (FIG. 2). The user selects “Radio” 44 from a functions menu using the scroll key 12c and the first soft key 12a (steps S1 & S2). The user can tune-in to the radio station 1 either by selecting an option 45 to scan through frequencies or select an option 46 to choose a pre-set frequency (step S3).

If the user elects to scan for a frequency, they are presented with a representation 47 of the radio spectrum (step S4). The user can either select the current frequency as indicated by a frequency identifier 48, in this example 95 MHz, or scan the spectrum for another frequency. If the user scans, then they can move to lower or higher frequencies using the first and second soft keys 12a, 12b respectively (step S5). While scanning, if a strong detected by the tuner 24 (FIG. 3) or the user stops and waits, then the display 11 presents the user with the option of selecting the new frequency or re-tuning (step S6). In this example, the user finds the appropriate frequency, in this example 102 MHz, and selects the frequency. The device 3 is tuned to the frequency, a signal is output by the speaker 10 and the frequency identifier 48 and a service identifier 49 is shown on the LCD 11. The station identifier 49, in this example “102 FM” is provided using RDS.

If the users chooses the option 46 to use pre-set stations (step S8), they are presented with a list of stations 50 through which they scroll until they find the desired station (step S9).

While listening to the radio, the user hears that the radio station 1 is running an opinion poll at the station's web-site. The URL of the web-site is announced by the presenter. The device 3 also receives the URL through RDS. The microcontroller 14 (FIG. 3) recognises that the RDS data includes a URL and displays the URL as a link 51 on the LCD 11 (step S10), as shown in FIG. 7.

Referring to FIG. 7, the user selects the link 51 (step S11) and downloads the web-page 41 from the server 6. The user is presented with the question “Who do you think should be mayor?” 52 and options “1. Candidate A” 53 and “2. Candidate B” 54 (step S12). The legends 43a, 43b indicate options “1” and “2” respectively as defined by the control script 42b. The user selects the option 53 by pressing the first soft key 12a. Alternatively, the same selection could be made by pressing “1” on the keypad 12. The LCD 11 presents a message 55 to the user asking them to verify their selection (step S13). It will be appreciated that this step need not be performed. A response is returned to the server 6 indicating the identity of the candidate. The response may include other information, for example, relating to the identity of the device 3. The response may be an XHTML document, an SMS message, e-mail or other data message. The device 3 displays a report 56 to the user that the response has been sent (step S14) and returns to the display showing the frequency 48 and, if available, the service identifier 49. It will be appreciated that while the user is voting, the radio can still be operated.

It the user wishes to manually enter the URL, for example because no RDS data has been received, the user may actuate the first soft key 12a and the scroll key 12c and select WAP service 57 from the functions menu (step S16). The user selects an option 58 to enter the URL using a text editor 59 (step S17 & S18). The user can also enter the telephone number of the server 6. Alternatively, the user can select a bookmark which holds the URL and, optionally, the telephone number of the web-site. A connection is established to the web-site as shown at step S11.

Referring to FIG. 8, an alternative method of selecting the candidate (step S12) involves a list of candidates 53, 54 through which the user can scroll using the scroll key 12c and select using the first soft key 12a, as indicated by the first legend 43a (step S12a). The choice can be verified, as described earlier (step S13). This method is better suited to polls which present the user with more than two options.

Selection of options using access key functionality, for example by pressing “1” on the keypad 12, can be used and is specified in the WAP specification, which can be obtained from at http://www.wapforum.org or WAP Forum, 2570 W. El Camino Real Suite 304, Mountain View, Calif. 94040-1313 USA.

Referring to FIG. 9, operation of the server 6 (FIG. 1) will now be described.

When the web-page 41 (FIG. 5c) is posted, a pair of counters are initialised, such that n₁=n₂=0 (step S19). The server 6 waits for the page 41 to be accessed and transmits the page 41 when requested (steps S20 & S21). The server 6 waits for a response (step S22). When it receives a response, it examines whether a vote has been cast for the first candidate (step S23). If so, the counter associated with the first candidate n₁ is incremented by one (step S24). Otherwise, the server 6 checks whether a vote has been cast for the second candidate (step S25) and if so, adds one to the second candidate's counter (step S26). The server 6 thereafter checks whether it has been instructed to report the results to the computer 32 (step S27). If has been so instructed, it reports the values of the counters. Otherwise, the server 6 continues to monitor the access to the web-page 41.

The production team member instructs the server 6 (FIG. 1) to report results. He informs the radio presenter of the results, who announces the results on-air.

It will be appreciated that the method described hereinbefore can be used for competitions involving multiple-choice answers. The method may be used for marketing, promotional or selling purposes. For example, it can be used to promote an album including a song which is being aired by the radio station 1. Thus, the message may include an offer to purchase a CD, tape or other music carrier at a reduced price provided the listener replies promptly. In this case the server can one set up for the promotion and may be associated with an advertising or record company. The user can make an electronic transaction using the device 3 either as an electronic wallet or in conjunction with an electronic wallet.

It will be appreciated that more than one server computer can be used. For example, a first server computer can be used to provide said poll and a second server computer can be used to receive votes.

Second Embodiment

Referring to FIG. 10, in a second embodiment of the present invention, a radio programme producer located at a production unit 60, which may or may not be a radio station, transmits a programme using digital audio broadcasting (DAB) through a single frequency (SFN) network 61 for reception by digital radio receivers (not shown) and a multi-functional communications device 62. The device 62 can communicate with mobile and fixed communications devices (not shown) through a PLMN 63, such as a GSM network.

In this embodiment, the device 62 receives a poll 64 though the broadcasting network 61, but sends a reply 65 through the PLMN 63. The radio programme producer 60 receives the reply and produces a poll result 66.

Referring to FIG. 11, the production unit 60 is provided with a microphone 67, music player 68, a mixing desk 69, audio encoder 70, channel encoder 71 and personal computer 72. The personal computer 72 is used to access a server computer 73. The server computer 73 is connected to a PSTN 74 using a modem (not shown) for connection to PLMN 63.

A radio programme is produced and comprises a stream of audio content 75. The audio content 75 includes speech, music and other audio signals. The microphone 67 and music player 68 produce audio signals 76 which are processed and mixed at the mixing desk 69. Audio signals 76 may also be produced by the personal computer 72. The music player can provide information data 77, for example relating a CD track number or identity of an artist.

Referring to FIG. 12, the audio encoder 70 generates DAB audio frames 78. Each audio frame 78 includes a header 79, bit allocation 80, scale factors 81, audio sub-band samples 82, programme associated data (PAD) 83, scale factor 84 and cyclical redundancy coding (CRC) 85. The channel encoder 71 subjects the audio frames 78 to energy dispersal scrambling, convolutional coding and time interleaving. The encoded and interleaved data 86 is passed to the rest of the transmission network 61′, where it is multiplexed with audio channel data from other programmes, together with an auxiliary information channel (AIC) and packet-mode data stream-mode data to form a main service channel (MSC). This is multiplexed with fast information channels and distributed throughout a plurality of transmitter stations for orthogonal frequency division multiplexing (OFDM) and subsequent broadcast. The radio programme is one of a plurality of radio programmes and services to be transmitted using a single block of frequencies, which is commonly called a “multiplex”. In the UK, several multiplexes have been allocated including one for national radio at 225.648 MHz.

An overview of DAB and technical information may be obtained at http://www.worlddab.org or from the Promotion Engineer, Dr. Wolfram Titze, c/o Robert Bosch Multimedia-Systeme GmbH, P.O. Box 77 77 77, D-31132 Hildesheim, Germany.

Referring to FIGS. 13 and 14, the device 62 is at least dual-function in that it provides mobile telephone functionality and digital audio broadcast receiver functionality. In this example, the device 62 is WAP-enabled. The device 62 includes a microphone 87, speaker 88, liquid crystal display (LCD) 89, keypad 90 and internal antenna element 91. The keypad 90 includes first and second soft keys 90a, 90b, a bi-directional scroll key 90c and an alphanumeric set of keys 90d.

Referring to FIG. 14, the circuitry of the mobile communications device 62, includes a microcontroller 92, RAM/ROM 93 and flash memory 94. Electrical analogue signals are produced by the microphone 87 and amplified using amplifier 95. Similarly, analogue audio signals are fed to the speaker 88 through an amplifier 96. The microcontroller 92 receives instructions from the keypad 90 and controls operation of the LCD 89. Information concerning the identity of the user is held on a smart card 97 in the form of a GSM SIM card. The SIM card 97 is removably received in a SIM card holder 98 connected to the microcontroller 92.

Communication radio signals, to and from the PLMN 63 (FIG. 10), are transmitted and received by means of the antenna element 91 connected through a r.f. stage 99 to a codec 100, which is configured to process signals under the control of the microcontroller 92.

DAB signals from the SFN broadcasting network 61 (FIG. 10) are received using an internal aerial 101 connected to a DAB radio interface 102 for tuning and selecting a multiplex. The output of the interface 102 is fed into a decoder 103. The decoder 103 includes an OFDM demodulator (not shown) for retrieving the MSC and FIC, a channel decoder (not shown) for eliminating transmission errors and an audio decoder for producing audio signals. It will be appreciated that a single antenna can be used to feed signals to the r.f. stage 99 and DAB radio interface 102. It will also be appreciated that the DAB and GSM radio interfaces 99, 102 may be integrated into a single unit. The handset 62 is powered by a rechargeable battery 104 or power source (not shown).

When the device 62 is used as a mobile telephone handset, the codec 100 receives analogue signals from the microphone amplifier 95, digitises them into a form suitable for transmission and feed them to the r.f. stage 99 for transmission through the antenna element 91 for transmission to the PLMN 63 (FIG. 10). Similarly, signals received from the PLMN 38 (FIG. 10) are fed through the antenna element 91 to be demodulated by the r.f. stage 99 and fed to codec 100 so as to produce analogue signals which are fed though the amplifier 96 to speaker 88.

When the device 62 is used as a DAB receiver, signals received from the SFN 61 (FIG. 10) are fed through the aerial 101 to the interface 102 where a multiplex is selected and fed to the decoder 103. Audio signals are amplified and fed to the speaker 88, while data received in a PAD and FIC are fed to the microcontroller 92.

Thus, the mobile communications device 62 can be used as a mobile communications handset for voice and data services and as a DAB receiver. These sets of functions can be performed separately or simultaneously. For example, a user can send a text message while listing to the radio.

The device 62 is also configured to operate as a client to receive data from remote servers and to communicate through PLMN 63 (FIG. 10) with either a gateway (not shown) which acts as a proxy server for connection to remote servers or directly with the remote server. For example, for a WAP-enabled system, access to the gateway is provided by dialling a telephone number associated with the gateway, although other communication techniques can be used e.g. for GPRS and UMTS. The server (not shown) may provide data corresponding to individual sites each with an individual homepage with a specific network address or universal resource locator (URL). The data may be provided in WML through the PLMN 63 (FIG. 10) to the device 62, which acts as a mobile client. Instead of using WML, the data may be provided in XHTML from the server (not shown), through the PLMN 63 (FIG. 10) to the device 62 without the need for a gateway. XHTML is a follow-on version to HTML 4.0.

The device 62 runs a microbrowser. The software for running the microbrowser may be held in flash memory 94 shown in FIG. 14, so as to be run by the microcontroller 92 and provide an output on display 89.

A radio programme presenter spontaneously decides to conduct an opinion poll as to listeners' favourite colours.

Referring to FIG. 15a, a member of the production team prepares the poll the using personal computer 72 (FIG. 11). In this example, the poll is presented as an XHTML page, although it will be appreciated it can be presented in a different format, such as an SMS message. The team member amends a template XHTML page 104. The page 104 includes a first dialogue box 105 for entering a question and a plurality of additional dialogue boxes 106a, 106b, 106c, 106d for entering possible answers.

Referring to FIG. 15b, the production team member enters a poll question “What is your favourite colour?” in the first dialogue box 105 and enters the names of two colours in first and second additional dialogue box 106a, 106b. Once completed, the production team member selects “Done” 107. The personal computer 72 (FIG. 11) adds further information such as a time stamp and information relating to the identity of the server computer, such as telephone number, e-mail address and/or URL.

Referring to FIG. 15c, a completed page 108 includes text 109a relating to the poll question and answers and also script 109b for configuring the device 62, particularly the device's user interface.

Referring to FIG. 16, the page 108 is included in the PAD 83 (FIG. 11) and fed into the audio encoder 70 (step S29). The page 108 can be transmitted repeatedly. Using the personal computer 72 (FIG. 11), the team member also notifies the server computer 73 (FIG. 11) to expect to receive votes (step S30). As will be explained in more detail later, when the page 108 containing the poll 64 (FIG. 10) is received by a listener and the listener can vote using the keypad 90. The vote 65 (FIG. 10) is transmitted to the server computer 73 (FIG. 11), where it is logged.

A process by which the user listens to a digital radio programme and interacts with the programme maker will now be described.

In FIG. 17, outputs are displayed on the LCD 89 including first and second legends 110a, 110b indicating the function of the first and second soft keys 90a, 90b (FIG. 13). The user selects “Digital Radio” 111 from a functions menu using the scroll key 90c and the first soft key 90a (steps S31 & S32). The user selects a station from a pre-defined list of stations 112 (steps S33 & S34). Alternatively, a list of service providers is transmitted as general data in the MSC and is displayed on the LCD 89. The device 62 selects the chosen programme from the multiplex and supplies an audio signal to the amplifier 96 (FIG. 14). A service identifier 113 is displayed on the LCD 89 (step S35).

Referring to FIG. 18, a notification 114 is displayed on the LCD 89 that a message has been received (step S36). The user elects to read the message. The microcontroller 92 (FIG. 14) loads the microbrowser and displays the poll question “What is your favourite colour” 115 together with possible answers “1. Red” 116 and “2. Blue” 117, as defined by the poll test 109a (step S37). The legends 110a, 110b indicate options “1” and “2” respectively, as defined by the control script 109b. The user selects “Red” by pressing the first soft key 90a (FIG. 13) and the LCD 89 presents a message 118 to the user asking them to verify their selection (step S38). Notification 119 is displayed that the vote has been cast (step S39). The microbrowser is closed and the handset resumes normal DAB operation (step S40).

The device 62 transmits the vote as an e-mail message to the server computer 73 (FIG. 11), whose e-mail address is included in the page 108. Each option is assigned a different e-mail address, for example “option1@102FM.com” for red and “option2@102FM.com” for blue. Alternatively, the vote can be sent to the same e-mail address and the vote extracted. The vote can be sent using other types of data message, including SMS, WML or XHTML documents.

Operation of the server 73 (FIG. 11) will now be described.

Referring to FIG. 19, a pair of counters are set, such that n₁=n₂=0 (step S41). The server 73 waits for a response (step S42). When it receives a response, it examines whether a vote has been cast for the first colour (step S43). If so, the counter associated with the colour n₁ is incremented by one (step S44). Otherwise, the server 73 checks whether a vote has been cast for the second colour (step S45) and if so, adds one to the second colour's counter (step S46). The server 73 thereafter checks whether it has been instructed to report the results to the computer 73 (FIG. 11) (step S47). If it has been so instructed, it reports the values of the counters. Otherwise, the server 73 continues to monitor received messages.

The production team member can check the counters using the personal computer 72. He informs the radio presenter of the results, who announces the results on-air.

It will be appreciated that the poll need not be transmitted using PAD, but can be included as general data as a separate service, either in the form of a continuous stream or in packet-mode. Alternatively, the poll can be transmitted as part of the FIC. In these cases, the poll is forwarded to the rest of the network 61′ to be encoded and multiplexed.

Moreover, it will be appreciated that the vote can be sent in different formats, such as an SMS message.

Third Embodiment

Referring to FIG. 20, in a third embodiment of the present invention, a first mobile communications device 120 conducts a poll of other mobile communications device, including second device 121, through a PLMN 122, such as a GSM network.

In this embodiment, the first device 120 prepares and sends a poll 123 using SMS. The second device 121 sends a reply 124 using SMS.

Referring to FIG. 21, each device 120, 121 includes a microphone 125, speaker 126, liquid crystal display (LCD) 127, keypad 128 and internal antenna element 129. The keypad 128 includes first and second soft keys 128a, 128b, a bi-directional scroll key 128c and an alphanumeric set of keys 128d.

Referring also to FIG. 22, the circuitry of each mobile communications device 120, 121, includes a microcontroller 130, RAM/ROM 131 and flash memory 132. Electrical analogue signals are produced by the microphone 125 and amplified using amplifier 133. Similarly, analogue audio signals are fed to the speaker 126 through an amplifier 134. The microcontroller 130 receives instructions from the keypad 128 and controls operation of the LCD 127. Information concerning the identity of the user is held on a smart card 135 in the form of a GSM SIM card. The SIM card 135 is removably received in a SIM card holder 136 connected to the microcontroller 130.

Communication radio signals, to and from the PLMN 122 (FIG. 20), are transmitted and received by means of the antenna element 129 connected through a r.f. stage 137 to a codec 138, which is configured to process signals under the control of the microcontroller 130. Each handset 120, 121 is powered by a rechargeable battery 139 or power source (not shown).

When each device 120, 121 is used, the codec 138 receives analogue signals from the microphone amplifier 123, digitises them into a form suitable for transmission and feed them to the r.f. stage 137 for transmission through the antenna element 129 for transmission to the PLMN 122. Similarly, signals received from the PLMN 122 are fed through the antenna element 129 to be demodulated by the r.f. stage 137 and fed to codec 138 so as to produce analogue signals which are fed though the amplifier 134 to speaker 126.

A method by which a first user, Alice, prepares and transmits a poll will now be described.

In FIG. 23, outputs are displayed on the LCD 127 including first and second legends 140a, 140b indicating the function of the first and second soft keys 128a, 128b. Alice is organising a visit to the cinema with her friends and wants to know how many tickets to buy. She decides to send a poll to her friends asking them whether they want her to buy a ticket for them. Alice selects “Messages” 141 from a functions menu (steps S41 & S42), chooses a “Poll” menu 142 (step S43) and chooses an option 143 to write a poll (step S44).

Alice first prepares the poll. Using the alphanumeric keypad 128d, she writes a poll question 144, such as “Shall I get a ticket for you?” (step S45). She then indicates how many options are available. In this example, there are only two options and so she selects “2” from a list 145 (step S46). The handset 120 prompts her to enter poll options, which in this case are “Yes” 146 and “No” 147 (steps S47 & S48). Alice then reviews the poll 148 she has prepared (step S49) and indicated that she is prepared to send the poll by selecting “Send poll” option 149 (step S50).

Alice then sets-up a distribution list. She selects an option 150 to add to the list (step S51). Then she enters telephone numbers using a text editor 151 or selecting names from her list of numbers stored on the SIM card 135 or flash memory 132 (step S52 & S53). She repeats steps S51 to S53 until she has identified all the intended recipients. When the distribution list is complete, she chooses an option 152 to send the poll (step S54). The poll is sent to each recipient as an SMS message in a manner well known per se. The handset 120 confirms that the poll has been sent with a notice 153 (step S55) and returns to an idle state (step S56).

A method by which a second user, Bob, receives and replies to a poll will now be described.

FIG. 24 shows outputs displayed on the LCD 127 of Bob's device 121. The device 81 is in an idle state (step S57). The poll is received and the device 81 alerts Bob with an icon or message 154 that a poll has been received (step S58). Bob can also be altered using a sound alert. Bob elects to read the poll and selects Alice's poll 155 from a list (step S59). The poll question and options 156 are displayed on the LCD 127 (step S60). The legends 140a and 140b indicate the options available to Bob. Bob presses the first soft key 128a to indicate “Yes”. The LCD 127 presents a query 157 to confirm his choice (step S61). Once Bob confirms his choice, the device 121 indicates with a notice 158 that his vote has been cast (step S62).

Referring to FIG. 25, which shows outputs displayed on Alice's LCD 127, the handset 120 is in an idle state (step S63). Bob's vote is received and the device 120 alerts Alice with an icon or message 159 that a vote has been received (step S64). Alice elects to view the vote and the results 160 of the poll so far (step S65). In this example, Alice also views poll statistics 161, such as poll share and turnout (step S66). Alice decides to share the result of the poll with everyone else. Therefore, she chooses an option 162 to transmit the results of the poll to the recipients in the original distribution list (step S67 & S68).

It will be appreciated that recipients, in addition to casting a vote, can add a message when replying. This involves entering a text editor, for example after making a selection, and entering a message. Once the message been entered, the message, together with the vote, are transmitted to the poll initiator, which in this case is Alice.

Fourth Embodiment

Referring to FIG. 26, in a fourth embodiment of the present invention, the multi-functional mobile communications device 3 is used participate in radio chat by sending an SMS message through the PLMN 4 to the radio programme producer, namely radio station 1. The radio station 1 converts the SMS into a voice signal and transmits the voice signal, preferably a VHF-FM signal, through the broadcasting network 2 for reception by radio receivers (not shown), including other multi-functional mobile communications devices. In this example, the device 3 need not be WAP-enabled.

A method by the user can send a chat message to be announced during the radio programme in the course of a song break, will now be described.

Referring to FIG. 27, which shows outputs on the LCD 11, the device 3 is tuned to listen to the radio station 1, as hereinbefore described with reference to FIG. 6 (step S69). The user indicates that they wish to use other functions by selecting a menu option 163 (step S70) and selects from a functions menu “Messages” 164 (step S71). The user elects to write a message (step S72) and is presented with a text editor (step S73). The user types a message using the alphanumeric keypad 12d (FIG. 2) “Hi Bob” 165 (step S74) and chooses an option 166 to send the message (step S75). The user then enters the telephone number 167 for the radio station (step S76). Alternatively, the user can select the telephone number from a list stored in the SIM card 19 or flash memory 16 (FIG. 3). The telephone number may be transmitted as RDS data, temporarily stored in and then retrieved from RAM 15 by the user. Once a number has been entered, the message is transmitted. Confirmation 168 of successful transmission is displayed (step S77).

Referring to FIG. 28, the server computer 6 (FIG. 4) receives the message (step S78) and places it at the bottom of a stack (step S79).

Referring to FIG. 29, when an suitable moment arrives, such as during a song break, the personal computer 32 (FIG. 4) removes a set number of messages from the top of the stack and using a text-to-voice application converts the message into a voice message (step S81) which is fed to the mixing desk 26 (FIG. 4) for broadcast (step S82). The number of message retrieved for conversion can be set by the radio station 1. For example, one message can be retrieved at a time. The personal computer 32 can pre- or post-process the messages, for example to improve grammar or check for inappropriate words or phrases, using for example T9™.

In the embodiment just described, the listener is charged a flat rate for sending a text message 165.

In an alternative embodiment, when the user prepares the text message 165, they can elect to be charge different rates and this determines when their message is broadcast.

Referring to FIG. 30, the server computer 32 receives a message (step S83), together with an indication of the rate charged. If the user has elected to be charged at a first, high rate, for example £2, then the message is passed to the personal computer 32 (FIG. 4) for immediate conversion and transmission (step S84 & S85). If the user elects to be charged at a second, lower rate, for example 60p, then the message is placed near, or at, the top of the stack (steps S86 & S87). If the user elects to be charges at a third, still lower rate, for example 20p, then the message is placed at the bottom of the stack (step S88).

It will be appreciated that the device 3 need not provide broadcast radio receiver functionality to send chat messages.

Fifth Embodiment

Referring to FIG. 26, in a modification of the fourth embodiment, the message is broadcast using RDS rather than as a voice message. This allows users to participate in chat using their mobile communications devices. The device 3 need not be WAP-enabled.

The user prepares an SMS message on the device 3 (FIG. 1) as hereinbefore described with reference to FIG. 27. The server computer 6 (FIG. 4) places the message in a stack as described earlier with reference to FIG. 28.

Referring to FIG. 31, the personal computer 32 retrieves the message on the top of the stack held on the server computer 6 (step S89). The message is then transmitted on the RDS sub-carrier (step S90). The SMS message can be divided and sent as several RDS messages. This is because the SMS message can be as long as 160 characters long, while RDS messages tend to be limited to 32 or 64 characters.

Referring to FIG. 32, the RDS signal is received by mobile communication devices (not shown), including device 3, having an FM receiver and other receivers (not shown). The device 3 shows an alert 169 that a message been received (step S91) and gives the user an option to read the message (step S92). The message 170 is then displayed.

Referring to FIG. 33, the message can also be presented in a “ticker tape” format 171, with text incoming from the right of the screen and outgoing to the left.

It will be appreciated that the device 3 need not provide broadcast radio receiver functionality to send chat messages. The user may send chat messages using mobile communications device 3 and receive chat messages from other participants using a separate digital receiver set having a display for showing chat messages broadcast using RDS.

Sixth Embodiment

The fifth embodiment can be modified still further to provide an easier environment for conducting chat using devices such as that shown in FIG. 1.

Referring to FIG. 34, first and second communications devices 3₁, 3₂ are used by Alan and Barbara respectively. Each device 3₁, 3₂ can receive VHF-FM signals from radio station 1 through broadcasting network 2 and can communicate with other devices (not shown), including each other, through PLMN 4. Features of the station 1, broadcasting network 2, devices 3₁, 3₂, PLMN 4 and server 6 are described earlier with reference to FIGS. 1 to 9. The devices 3₁, 3₂, however, need not be WAP-enabled. The server 6 need not be a WAP-server. The server 6 is configured to receive data messages, such as SMS messages.

In FIG. 35, outputs are displayed on LCD 11 of Alan's device 3₁ including first and second legends 43a, 43b indicating the function of the first and second soft keys 12a, 12b (FIG. 2). Alan selects “Chat” 172 from the functions menu using the scroll key 12c and the first soft key 12a (step S91). Alan can then enter an alias or nickname using a text editor 173 (step S92). An alias or nickname can be used to preserve the anonymity of the user. It will be appreciated that chat users, such as Alan, may have had to register the alias or nickname with the radio station 1 in advance. It will also be appreciated that the alias or nickname can be valid for a single chat session. Alan then enters the telephone number or, if appropriate the URL, of the server 6 using a text editor 174 or selects the number from list held on the SIM card 19 (FIG. 3) or flash memory 16 (FIG. 2) (step S93). Alan then enters a chat message “Hi Barbara” 175 (steps S94 & S95). Alan then chooses to send the chat message 175 and the LCD 11 displays a confirmation 176 that the chat message has been sent (step S96).

Alan's chat message 175 is sent as a data message, such as an SMS message, to the server computer 6 where it is placed in a stack, as described with reference to FIG. 28. Alan's chat message 175 is then retrieved and broadcast using one or more RDS messages, as described with reference to FIG. 31. Further information may be appended to the chat message 175, such as the telephone number of the server 6. The chat message 175 is received by radio receiver sets (not shown) including Barbara's device 3₂.

In FIG. 36, outputs are displayed on LCD 11 of Barbara's device 3₂ including first and second legends 43a, 43b indicating the function of the first and second soft keys 12a, 12b (FIG. 2). Her device 3₂ is tuned to listen to the radio station 1, as described earlier with reference to FIG. 6.

Alan's message 175 is received and processed by the microcontroller 14 (FIG. 3) and stored in RAM 15 (FIG. 3). The LCD 11 shows an alert 177 that a chat message been received (step S97) and gives Barbara an option to read the chat message. A message 178, corresponding to Alan's message 175, is displayed (step S98). The displayed message 178 may also include further information relating to the Alan's identity, a telephone number and/or an icon, such as a symbol or picture. Barbara can enter an options menu and select an option 179 to reply to the chat message (step S99). Barbara enters a text editor and types a reply “Hi Alan” 180 (steps S100 & S101). She then chooses to send the reply message 180 and the LCD 11 displays a confirmation 181 that the chat message has been sent (step S102). It will be appreciated that Barbara can enter the telephone number of the server 6 manually should this not be appended to Alan's chat message 175.

Barbara's chat message 180 is sent as a data message, such as an SMS message, to the server computer 6 where it is placed in a stack, as described earlier. Barbara's chat message 180 is then retrieved and broadcast using one or more RDS messages, as described earlier. Barbara's chat message 180 is received by radio receiver sets (not shown) including Alan's device 3₁.

If Alan is listening to the radio station 1 using his device 3₂ then he will receive Barbara's chat reply. In this way, Alan and Barbara can participate in chat. It will be appreciated that more users can participate in chat, since the chat messages 175, 180 are broadcast.

Referring to FIG. 37, chat messages 178, 180 within a chat session can be presented in sequence. Each chat message 178, 180 can be displayed beginning with a chat name 181, for example a nickname or an abbreviation. Using the scroll key 12c, a user can view the chat session.

Referring to FIG. 38, different chat channels or “chat rooms” can be defined. Chat messages can be given a header corresponding to a chat room. For example, a first chat room can be used to discuss who should become the next mayor and a second chat room may discuss the topic of favourite colours.

A procedure by which chat rooms ate employed will now be described.

A chat user, such as Alan or Barbara, selects “Chat” 172 from the functions menu using the scroll key 12c and the first soft key 12a (step S103). The user then selects an option 182 to pick a chat room (step S104). Thereafter, they select a topic 183 (step S105). A chat session 184 for that topic can be retrieved from memory 15, 16, 19 (FIG. 3) and displayed (step S106). Chat messages can be written and sent as described earlier. If a chat message is received and is concerned with a particular topic, this can be stored according to the topic.

It will be appreciated that if chat messages are sent using SMS, messages may be forwarded to the server via an SMS centre.

It will be appreciated that examples of mobile communications devices include PDAs, gaming devices and remote handheld devices for home entertainment systems.

The invention is not restricted to the use of WAP technology but can be used in any mobile telecommunications system in which mobile devices act as clients for remote servers. It will be appreciated that mobile communication devices using services such as i-mode, GPRS and UMTS may be used.

It will be appreciated that each of the preceding embodiments include a number of advantageous features and that these features can be used in different combinations within or without the described embodiments to which they relate, and such combinations are to be considered as encompassed by the claims hereinafter.

1. A method of providing live feedback to a producer of a broadcast programme using a mobile communication device, the method comprising:
receiving, at said device, a stream of programme content and a message for a user of said device to respond thereto; and
transmitting, from said device, a response to a server computer associated with the producer for providing feedback while said stream is still being received.

2. A method according to claim 1, wherein said programme content is radio programme content.

3. A method according to claim 1, wherein said programme content is television programme content.

4. A method according to any one of claims 1 to 3, comprising extracting said message from said stream of programme content.

5. A method according to any one of claims 1 to 3, comprising receiving said stream of programme content via a first network and receiving said message via a second, different network.

6. A method according to claim 5, wherein said receiving said message via a second, different network comprises obtaining said message via a public land mobile network.

7. A method according to claim 1 to 3, wherein said receiving of said message includes receiving information relating to a plurality of selectable options.

8. A method according to claim 7, further comprising configuring said device in dependence upon said message such that each option is assigned a respective input means.

9. A method according to claim 7, wherein said transmitting said response comprises sending a response message relating to one of said selectable options.

10. A method according to claim 1 to 3, further comprising the user making an electronic transaction.

11. A method according to claim 1 to 3 comprising:
transmitting to one or more mobile communications devices said message including information relating to a plurality of selectable options;
receiving a response from at least some of said devices, each response including data relating to a selected one of said options; and
generating a poll result from said responses.

12. A method according to claim 1 to 3 comprising:
preparing a chat message using a mobile communications device;
transmitting said chat message via a communications network to a server means associated with the producer;
broadcasting said chat message via a broadcasting network.

13. A method of providing live feedback to a producer of a broadcast radio programme using a mobile communications device, the method comprising:
transmitting a stream of radio programme content from the producer to the device; transmitting a message originating from the producer for a user of said device to respond thereto; and
receiving, at a server means associated with said producer, a response to while said stream is still being transmitted.

14. A method according to claim 13 comprising:
transmitting to one or more mobile communications devices said message including information relating to a plurality of selectable options;
receiving a response from at least some of said devices, each response including data relating to a selected one of said options; and
generating a poll result from said responses.

15. A method according to claim 13 or 14 comprising:
preparing chat message using a mobile communications device;
transmitting said chat message via a communications network to a server means associated with the producer;
broadcasting said chat message via a broadcasting network.

16. A system for allowing a mobile communications device to provide live feedback to a producer of a broadcast radio programme, comprising:
means for producing a stream of radio programme content from the producer to the device;
means for transmitting a message originating from the producer for a user of said device to respond thereto;
server means for receiving a response to said message while said stream is still being producing.

17. A system according to claim 16, wherein said means for transmitting said message for said user of said device to respond thereto includes means for producing radio system data (RDS).

18. A system according to claim 16, wherein said means for transmitting said message for a user of said device to respond thereto includes a digital audio broadcasting network.

19. A system according to claim 18, wherein said message is included in a digital audio frame.

20. A system according to claim 18, wherein said message is included in programme associated data included in said digital audio frame.

21. A system according to claim 15, wherein said means for transmitting said message for a user of said device to respond includes said and/or another server means.

22. A system according to claim 20, wherein said message is included in a page provided by said server means.

23. A system according to claim 16 to 21, wherein said server means is a wireless application protocol (WAP) server.

24. A system for allowing a mobile telecommunications device to provide live feedback to a producer of a broadcast radio programme, comprising:
means for producing a stream of radio programme content;
means for transmitting a message originating from said producer for a user of said device to respond thereto;
means for receiving data, from a server means, relating to a response to said message, said data being received while said stream is still being produced.

25. A mobile communications device for providing live feedback to a producer of a broadcast radio programme, the device comprising:
means for receiving a stream of radio programme content from said producer;
means for receiving a message originating from said producer for a user of said device to respond thereto; and
means for transmitting a response to a server means associated with the producer for providing feedback while said stream is still being received.

26. A device according to claim 25, wherein said means for receiving said stream of radio programme content comprises means for receiving digital radio broadcast (DAB).

27. A device according to claim 25 or 26, wherein said means for receiving said message comprises means for receiving digital radio broadcast (DAB).

28. A device according to claim 25, wherein said means for receiving said message comprises means for receiving broadcast radio.

29. A device according to claim 28, wherein said means for receiving said message comprises means for radio data system (RDS) data.

30. A device according to claim 25, wherein said means for receiving said message comprises means for accessing said and/or another server means.

31. A device according to claim 25, which is WAP-enabled.

32. A device according to claim 25, which is a handset.

33. A device according to claim 25 which is a PDA.

34. A method of conducting a poll, the method comprising:
transmitting to one or more mobile communications devices a message including information relating to a plurality of selectable options;
receiving a response from at least some of said devices, each response including data relating to a selected one of said options; and
generating a poll result from said responses.

35. A method of broadcasting comprising:
preparing a message using a mobile communications device;
transmitting said message via a communications network to a server means associated with a radio broadcaster;
broadcasting said message via a broadcasting network.

36. A method of chat comprising:
preparing a message using a mobile communications device;
transmitting said message via a communications network to a server means associated with a radio broadcaster;
broadcasting said message via a broadcasting network.

37. A method according to claim 35 or 36, comprising converting said message into a voice message and broadcasting said voice message via said broadcasting network.

38. A method according to claim 35 or 36, comprising broadcasting said message as data together with an audio signal.

39. A method according to claim 38, wherein said broadcasting of said data comprises transmitting radio data system (RDS) data.

40. A method according to claim 39, wherein said broadcasting of said data comprises transmitting a plurality of RDS data messages.

41. A method according to claim 35, comprising broadcasting said message using frequency modulated (FM) signals.

42. A method according to claim 35, wherein the receiving of said response comprises receiving a short message service (SMS) message.

43. A method of chat comprising:
receiving a chat message form a communications network; and
broadcasting a corresponding message via a broadcasting network.

44. A method according to claim 43, wherein the receiving of the chat message comprises receiving a short message service (SMS) message.

45. A method according to claim 43 or 44, wherein the broadcasting of said corresponding message comprises transmitting a radio data service (RDS) message.

46. A method according to claim 45, wherein the broadcasting of said corresponding message comprises transmitting a plurality of radio data service (RDS) messages.

47. A method of chat comprising:
receiving a chat message from a broadcasting network; and
transmitting a reply chat message to a server means via a communications network.

48. Apparatus for chat comprising:
means for receiving a chat message from a communications network; and
means for broadcasting a corresponding chat message via a broadcasting network.

49. Apparatus for chat comprising:
means for receiving a chat message from a broadcasting network; and
means for transmitting a reply chat message to a server means via a communications network.

50. Apparatus according to any one of claims 48 or 49, wherein the communications network is a mobile telecommunications network.
